(19) United States
(12) Patent Application Publication
(10) Pub. No.: US 2026/0213455 A1
(43) Pub. Date: Jul. 23, 2026

(54) ELECTRICAL CONNECTOR AND ELECTRICAL CONNECTOR ASSEMBLY

(71) Applicant: Molex, LLC, Lisle, IL (US)

(72) Inventors: Zhi Qiang Wang, Shanghai (CN); Hong Xu, Shanghai (CN)

(21) Appl. No.: 19/457,539

(22) Filed: Jan. 23, 2026

(30) Foreign Application Priority Data
Jan. 23, 2025 (CN) 202510114483.6

(51) Int. Cl. H01R 13/504; H01R 12/71; H01R 13/631

(52) U.S. Cl. CPC H01R 13/504; H01R 12/716; H01R 13/631

(57) ABSTRACT

An electrical connector and an electrical connector assembly are provided. The electrical connector includes a connector body, a plurality of terminals attached to the connector body and two strengthening members respectively attached to two ends of the connector body. Wherein, each strengthening member includes: an end wall covering portion attached to an end wall of the connector body; and a pair of side wall covering portions respectively attached to two side walls of the connector body, each side wall covering portion is connected to the end wall covering portion via a connecting portion; each side wall covering portion includes a side plate portion, an upper covering portion connected to an upper portion of the side plate portion and an extending portion connected to a part of the upper covering portion, the upper covering portion at least partially covers an upper portion of the side wall of the connector body, at least a part of the extending portion is completely embedded in the side wall of the connector body. By that at least a part of the extending portion is embedded in the side wall of the first connector body, engagement strength between the first strengthening member and the first connector body is promoted.

### TECHNICAL FIELD

The present disclosure relates to the field of electrical connectors, and specifically relates to an electrical connector and an electrical connector assembly.

### BACKGROUND

In the prior art, an electrical connector assembly is used to electrically connect a pair of circuit boards together, the electrical connector assembly includes an electrical connector and a counterpart electrical connector, the electrical connector and the counterpart electrical connector are respectively attached to two corresponding surfaces of a pair of circuit boards which face each other, the electrical connector and the counterpart electrical connector are mated with each other and are conducted by terminals. In order to improve use reliability of the electrical connector assembly, two ends of a connector body of the electrical connector and two ends of a connector body of the counterpart electrical connector are respectively provided with strengthening members. In use of the electrical connector assembly, after the electrical connector and the counterpart electrical connector are inserted into each other and are pulled out from each other many times, the strengthening member is prone to be separated from the connector body, after the strengthening member is separated from the connector body, the connector body lacks effective strengthening protection and is prone to be damaged.

### SUMMARY

In view of the problem in the prior art, an object of the present disclosure is to provide an electrical connector and an electrical connector assembly, which improve engagement strength between a strengthening member and a connector body by that at least a part of an extending portion of the strengthening member is embedded in the connector body.

A first aspect of the present disclosure provides an electrical connector comprising a connector body, a plurality of terminals attached to the connector body and two strengthening members respectively attached to two ends of the connector body. Wherein, each strengthening member comprises: an end wall covering portion attached to an end wall of the connector body; and a pair of side wall covering portions respectively attached to two side walls of the connector body, each side wall covering portion is connected to the end wall covering portion via a connecting portion; each side wall covering portion comprises a side plate portion, an upper covering portion connected to an upper portion of the side plate portion and an extending portion connected to a part of the upper covering portion, the upper covering portion at least partially covers an upper portion of the side wall of the connector body, at least a part of the extending portion is completely embedded in the side wall of the connector body.

In some embodiments, the extending portion comprises a connecting segment and an embedded segment, the embedded segment is connected to an inner side of the upper covering portion via the connecting segment, the embedded segment is completely embedded in the side wall of the connector body.

In some embodiments, the connecting segment extends downwardly and inwardly relative to the upper covering portion; the embedded segment extends outwardly relative to the connecting segment.

In some embodiments, two sides of the extending portion in a first direction each are provided with the connector body, the first direction is an extending direction of the side wall of the connector body.

In some embodiments, an upper surface of the upper covering portion and/or an upper surface of the connecting segment of the extending portion is not lower than an upper surface of the side wall of the connector body.

In some embodiments, a lower portion of the side plate portion is connected to a soldering portion; the soldering portion is exposed at a bottom surface of the connector body, the bottom surface of the connector body in positions respectively corresponding to two sides of the soldering portion along a first direction is provided with notches which each are recessed upwardly, the first direction is an extending direction of the side wall of the connector body.

In some embodiments, each strengthening member further comprises a bottom surface covering portion and two elastic arms; the two elastic arms are respectively connected to two sides of the bottom surface covering portion, and a top end of each elastic arm is provided with a contacting end, a height of the contacting end is lower than a height of the upper covering portion.

In some embodiments, after the electrical connector is mated with a counterpart electrical connector, the contacting end abuts against a counterpart strengthening member of the counterpart electrical connector, and the contacting end is positioned closer to a central axis of the connector body than a part of the extending portion which is exposed from the connector body.

In some embodiments, an upper surface of an inner side of the upper covering portion is an oblique surface, an angle between the oblique surface and a height direction is 50°-70°.

In some embodiments, each strengthening member further comprises a bottom surface covering portion, an upper side surface of the bottom surface covering portion is a stopping surface, the stopping surface is configured to stop a counterpart strengthening member of a counterpart electrical connector.

A second aspect of the present disclosure provides an electrical connector assembly comprising the electrical connector of the first aspect and a counterpart electrical connector which is mated with the electrical connector.

In some embodiments, each strengthening member further comprises a bottom surface covering portion, an inner side surface of the bottom surface covering portion serves as a first stopping surface; the counterpart electrical connector comprises a counterpart connector body and two counterpart strengthening members respectively provided at two ends of the counterpart connector body, each counterpart strengthening member comprises a second stopping surface, the first stopping surface and the second stopping surface abut against each other.

In some embodiments, the counterpart connector body comprises a recess, the connector body comprises a protrusion, the protrusion is fitted into the recess, and a top surface of the protrusion and a bottom surface of the recess therebetween have a gap in height.

In some embodiments, the counterpart electrical connector comprises a counterpart connector body and two counterpart strengthening members respectively provided at two ends of the counterpart connector body, the counterpart strengthening member comprises at least one counterpart soldering portion, the counterpart soldering portion is exposed at a top surface of the counterpart connector body; the top surface of the counterpart connector body in a position corresponding to the counterpart soldering portion is provided with at least one cooperating notch which is recessed downwardly, the at least one cooperating notch is positioned at two sides of the counterpart soldering portion along a first direction and/or the at least one cooperating notch is positioned at an inner side of the counterpart soldering portion, the first direction is an extending direction of the side wall of the connector body.

In some embodiments, the counterpart soldering portion comprises a soldering end portion which extends outwardly, a lower surface of the soldering end portion comprises a connecting plane and an oblique surface, the oblique surface extends from a side of the connecting plane toward an upper surface of the soldering end portion.

In some embodiments, the counterpart strengthening member further comprises a side covering portion and a transitioning portion, the counterpart soldering portion comprises a bending portion which bends inwardly and extends upwardly and a soldering end portion which extends outwardly, the bending portion is connected to the side covering portion via the transitioning portion, a connected location between an outer side surface of the transitioning portion and an outer side surface of the side covering portion is a straight line.

The electrical connector and the electrical connector assembly provided by the present disclosure has the following advantages: with the present disclosure, the two ends of the first connector body are respectively provided with the two first strengthening members, which strengthen protection for the end portions of the first electrical connector, the side wall covering portion of the first strengthening member is provided with the extending portion, and at least a part of the extending portion is completely embedded in the side wall of the first connector body, so that engagement strength between the first strengthening member and the first connector body is promoted, even if the first connector body is inserted into or pulled out from the second electrical connector many times, the first strengthening member is not prone to be separated from the first connector body, which provides continuous protection for the first electrical connector, and improves use reliability and service life of the electrical connector and the electrical connector assembly.

### BRIEF DESCRIPTION OF THE DRAWINGS

Other features, objects, and advantages of the present disclosure will become more apparent by reading the detailed description of non-limiting embodiments with reference to the accompanying drawings.

FIG. 1 is a schematic view when a first electrical connector and a second electrical connector of an embodiment of the present disclosure are not mated with each other.

FIG. 2 is a structure schematic view of the first electrical connector of the embodiment of the present disclosure.

FIG. 3 is a partially enlarged view of a region B1 of FIG. 2;

FIG. 4 is an exploded view of the first electrical connector of the embodiment of the present disclosure.

FIG. 5 is a structure schematic view of a first strengthening member of the embodiment of the present disclosure.

FIG. 6 is a structure schematic view of the first strengthening member of the embodiment of the present disclosure from another angle.

FIG. 7 is a top view of the first electrical connector of the embodiment of the present disclosure.

FIG. 8 is a cross-sectional view along a line A1-A1 of FIG. 7.

FIG. 9 is a cross-sectional view along a line A2-A2 of FIG. 7.

FIG. 10 is a structure schematic view of the second electrical connector of the embodiment of the present disclosure.

FIG. 11 is an exploded view of the second electrical connector of the embodiment of the present disclosure.

FIG. 12 is a top view of the second electrical connector of the embodiment of the present disclosure.

FIG. 13 is a partially enlarged view of a region B2 of FIG. 12.

FIG. 14 is a structure schematic view of a second strengthening member of the embodiment of the present disclosure.

FIG. 15 is a structure schematic view of the second strengthening member of the embodiment of the present disclosure from another angle.

FIG. 16 is a bottom view of an electrical connector assembly of the embodiment of the present disclosure.

FIG. 17 is a cross-sectional view along a line A3-A3 of FIG. 16.

FIG. 18 is a partially enlarged view of a region B3 of FIG. 17.

FIG. 19 is a partially enlarged view of a region B4 of FIG. 17.

FIG. 20 and FIG. 21 are structure schematic views of a second strengthening member of another embodiment of the present disclosure.

### DETAILED DESCRIPTION

Example embodiments will be more comprehensively described now with reference to the drawings. However, the example embodiments can be implemented in many forms and are not considered to be limited to the embodiments described herein, on the contrary, providing these embodiments makes the present disclosure more thorough and comprehensive, and comprehensively conveys the concept of the example embodiments to a person skilled in that art. The same reference numerals in the figures indicate the same or similar structures, therefore repeated descriptions thereof will be omitted. The term “or” in the specification may indicate “and” or “or”. Although the terms “up”, “down”, “between” and the like may be used in the specification to describe different exemplary features and elements of the present disclosure, these terms are used only for convenience herein, for example, depending on the direction of the examples in the drawings. Any content in this specification should not be understood as requiring a specific three-dimensional orientation of the structure to fall within the scope of the present disclosure. Although the terms “first” or “second” and the like are used in the specification to indicate certain features, they are only intended to indicate function and do not serve as limitations on the number and importance of specific features.

Embodiments of the present disclosure provide an electrical connector and an electrical connector assembly. The electrical connector assembly includes the electrical connector and a counterpart electrical connector which is mated with the electrical connector. Hereinafter the electrical connector is referred to as a first electrical connector 100, the counterpart electrical connector is referred to as a second electrical connector 600. In use, the first electrical connector 100 and the second electrical connector 600 are respectively fixed to two corresponding surfaces of a pair of circuit boards (such as printing circuit boards or flexible printing circuit boards) which face each other, the first electrical connector 100 and the second electrical connector 600 are mated with each other and are conducted by terminals. The electrical connector assembly may be applied in electrical systems of various consumer products, medical products and the like.

Hereinafter for sake of distinguishing, a body of the first electrical connector 100 is referred to as a first connector body 10, a body of the second electrical connector 600 is referred to as a second connector body 60 (a counterpart connector body). A strengthening member provided to the first electrical connector 100 is referred to as a first strengthening member 30, a soldering portion of the first strengthening member 30 is referred to as a first soldering portion 304. A counterpart strengthening member provided to the second electrical connector 600 is referred to as a second strengthening member 80, a counterpart soldering portion of the second strengthening member 80 is referred to as a second soldering portion 804.

As shown in FIGS. 1-4, the first electrical connector 100 includes the first connector body 10, a plurality of first terminals 20 attached to the first connector body 10 and two first strengthening members 30 respectively attached to two ends of the first connector body 10.

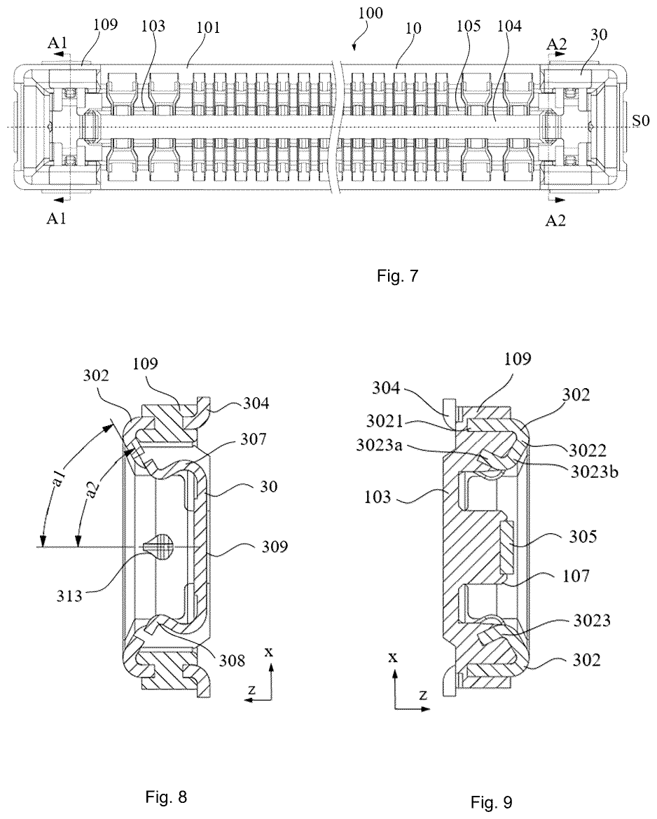

The first connector body 10 includes two side walls 101 which extend along a first direction, two end walls 102 which are positioned at two ends of the first connector body 10 in the first direction, and a bottom plate 103 (FIG. 7). A first protrusion 104 which extends along the first direction is provided above the bottom plate 103, is formed as an island portion, two ends of the first protrusion 104 along the first direction are provided with island end portions 107 respectively. Two sides of the first protrusion 104 and the two side walls 101 are respectively formed therebetween with first recesses 105 which extend along the first direction.

In figures of the drawings, “the first direction” refers to a y-axis direction, that is, the length direction of the first electrical connector 100. An x-axis direction refers to a width direction of the first electrical connector 100. A z-axis direction refers to a height direction of the first electrical connector 100, a positive direction along the z-axis is “up”, and an opposite direction along the z-axis is “down”. “An inner side” and “an outer side” of each component of the first electrical connector 100 of the present disclosure are with respect to a central axis SO (FIG. 7) of the first connector body 10 along the first direction, a side close to the central axis SO (FIG. 7) of the first connector body 10 is the inner side, a side away from the central axis SO (FIG. 7) of the first connector body 10 is the outer side. “An inner side” and “an outer side” of each component of the second electrical connector 600 are with respect to a central axis of the second connector body 60 along the first direction, a side close to the central axis of the second connector body 60 is the inner side, a side away from the central axis of the second connector body 60 is the outer side.

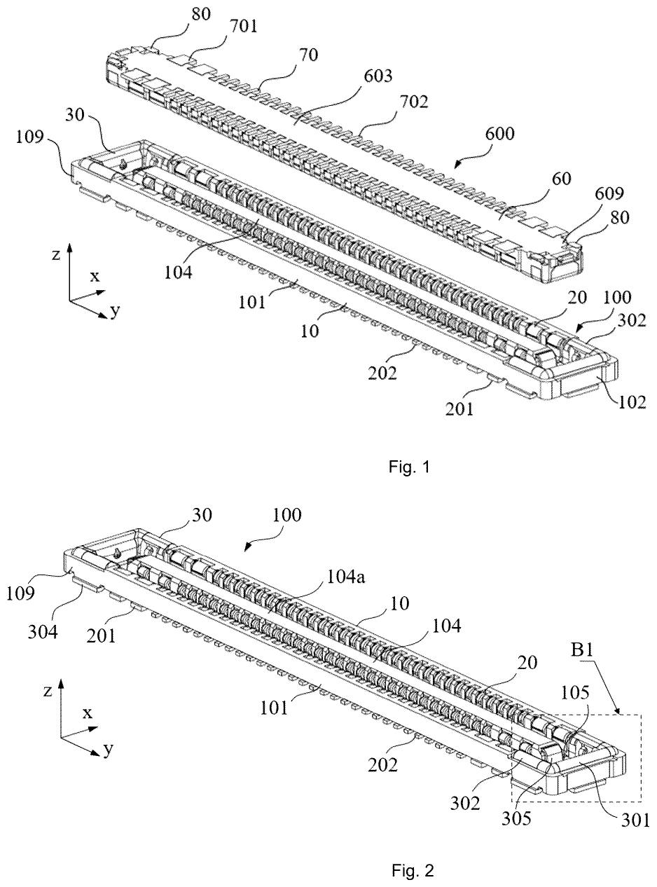

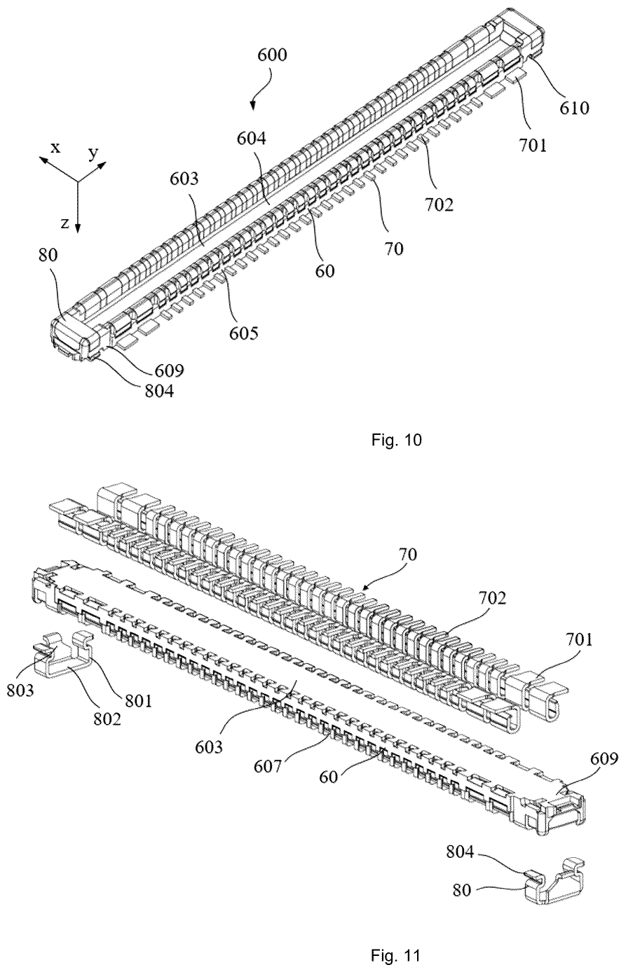

As shown in FIGS. 2-4, the two side walls 101 of the first connector body 10 are provided with first terminal receiving grooves, side surfaces of the first protrusion 104 are provided with second terminal receiving grooves, the first terminal receiving grooves and the second terminal receiving grooves together form first terminal receiving cavities 106 which are used to receive the plurality of first terminals 20. The plurality of first terminals 20 include a plurality of first power terminals 201 and a plurality of first signal terminals 202. The plurality of first power terminals 201 are provided between the plurality of first signal terminals 202 and the two first strengthening members 30. The first power terminal 201 is used to cooperate with a second power terminal 701 (FIG. 10) of the second electrical connector 600, so as to transmit power between the first electrical connector 100 and the second electrical connector 600. The first signal terminal 202 is used to cooperate with a second signal terminal 702 (FIG. 10) of the second electrical connector 600, so as to transmit a signal between the first electrical connector 100 and the second electrical connector 600. The plurality of first signal terminals 202 and the plurality of the first power terminals 201 employ different pitches therebetween. In the first direction, the pitch between the two adjacent first signal terminals 202 is, for example, 0.2 mm, and the pitch between the two adjacent first power terminals 201 is, for example, 0.7 mm, facilitating the arrangement of the plurality of first power terminals 201 which are larger.

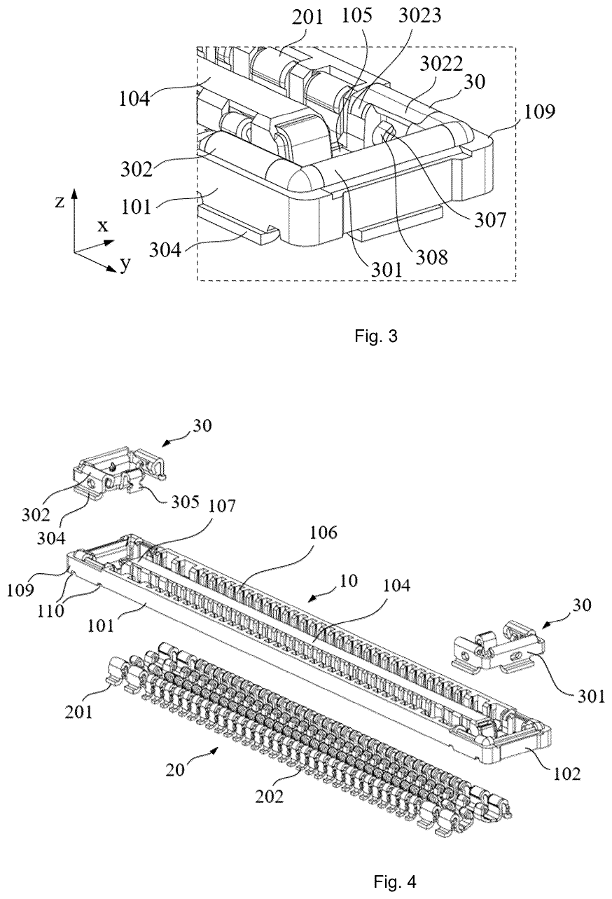

As shown in FIGS. 3-6, each first strengthening member 30 is provided on a first end portion 109 of the first connector body 10. The first connector body 10 is, for example, made from a plastic material or other macromolecule polymer material, hereinafter that the first connector body 10 is made from the plastic material is taken as example. The two first strengthening members 30 are made from a conductive metal material (for example copper, copper alloy, nickel alloy and the like), strengthen and protect the two first end portions 109 at the two ends of the first connector body 10 in structure, and effectively improve use reliability of the first electrical connector 100. The first connector body 10 and the two first strengthening members 30 may be formed by an overmolding process, the two first strengthening members 30 are placed into a mold of the first connector body 10, then a plastic material in liquid is injected to form the first connector body 10, so that the first connector body 10 and the two first strengthening members 30 are tightly engaged together. When the first electrical connector 100 and the second electrical connector 600 are mated with each other, the first strengthening member 30 and the second strengthening member 80 (FIG. 10) of the second electrical connector 600 also come into contact and establish electrical connection for power transmission. Each first strengthening member 30 includes an end wall covering portion 301, a pair of side wall covering portions 302, an island end covering portion 305 and a bottom surface covering portion 309. The end wall covering portion 301 is attached to the end wall 102 of the first connector body 10. The two side wall covering portions 302 are respectively attached to the two side walls 101 of the first connector body 10, each side wall covering portion 302 is connected to the end wall covering portion 301 via a connecting portion 306. The bottom surface covering portion 309 at least partially covers a bottom surface of the first end portion 109. Two sides of the bottom surface covering portion 309 in the y direction are respectively connected to the end wall covering portion 301 and the island end covering portion 305. The island end covering portion 305 is attached to the island end portion 107 of the first connector body 10.

As shown in FIGS. 3-6, each side wall covering portion 302 includes a side plate portion 3021, an upper covering portion 3022 connected to an upper portion of the side plate portion 3021, and an extending portion 3023 connected to a part of the upper covering portion 3022.

The upper covering portion 3022 at least partially covers an upper portion of the side wall 101 of the first connector body 10. At least a part of the extending portion 3023 is completely embedded in the side wall 101 of the first connector body 10. As shown in FIG. 7 and FIG. 9, the extending portion 3023 includes a connecting segment 3023b and an embedded segment 3023a, the embedded segment 3023a is connected to the upper covering portion 3022 via the connecting segment 3023b, the embedded segment 3023a is completely embedded in the side wall 101 of the first connector body 10, the embedded segment 3023a further strengthens engagement strength between the first strengthening member 30 and the first connector body 10. Even if the first electrical connector 100 and the second electrical connector 600 are inserted into each other and are pulled out from each other many times, the first strengthening member 30 is not prone to be separated from the first connector body 10, and provides continuous protection for the first electrical connector 100, which further improves use reliability and service life of the first electrical connector 100 and the electrical connector assembly.

As shown in FIG. 7 and FIG. 9, an upper side of the connecting segment 3023b is connected to an inner side of the upper covering portion 3022, a lower side of the connecting segment 3023b is connected to an upper side of the embedded segment 3023a. The connecting segment 3023b extends downwardly and inwardly relative to the upper covering portion 3022, the embedded segment 3023a extends outwardly relative to the connecting segment 3023b.

Therefore, relative to the upper covering portion 3022, the extending portion 3023 firstly extends downwardly and inwardly, and then extends outwardly, so the extending portion 3023 is embedded into an interior of the side wall 101 at a certain angle from the side wall 101 of the first connector, and forms tight engagement relationship with the side wall 101.

As shown in FIG. 3, two sides of the extending portion 3023 in the first direction each are provided with the first connector body 10. In the first direction, the first connector body 10 forms an overmolding on the two sides of the extending portion 3023, which blocks the extending portion 3023 to displace toward the two sides of the extending portion 3023 along the first direction, so that the first strengthening member 30 is not prone to displace relative to the first connector body 10 in the first direction.

As shown in FIG. 1 and FIGS. 7-9, in a process that the second electrical connector 600 and the first electrical connector 100 are mated with each other, the upper covering portion 3022 of the side wall covering portion 302 is further used to provide guiding for mating of the second electrical connector 600. A top surface of the upper covering portion 3022 is an arc surface, and an upper surface of the inner side of the upper covering portion 3022 is an oblique guiding surface which extends downwardly and inwardly. The oblique guiding surface is positioned above an elastic arm 307. As shown in FIG. 8, an angle al between the oblique guiding surface and the height direction is 50°-70°, and may be selected as 60°, which assures that a second end portion 609 of the second electrical connector 600 can be aligned with and fitted into a recessed groove within the first end portion 109 when the second electrical connector 600 is mated with the first electrical connector 100. Here, a value range of the angle al is only taken as example, and is not used to limit a protect scope of the present disclosure, in other alternative implementing manners, the angle al also may employ an angle value which is not listed here. An angle a2 between an outer surface of an end portion of the elastic arm 307 and the height direction is not less than the angle al, which avoids the end portion of the elastic arm 307 protruding inwardly relative to the oblique guiding surface to affect the guiding function of the oblique guiding surface for the second electrical connector 600, and also avoids the second electrical connector 600 presses the end portion of the elastic arm 37 down to make the elastic arm 37 abnormally deformed when the second electrical connector 600 is inserted into the first electrical connector 100. As shown in FIG. 1 and FIG. 9, an upper surface of the upper covering portion 3022 is not lower than an upper surface of the side wall 101 of the first connector body 10, so that, when the second electrical connector 600 is inserted into the first electrical connector 100, the second end portion 609 of the second electrical connector 600 firstly contacts the first strengthening member 30, the first strengthening member 30 bears an acting force of the second end portion 609 of the second electrical connector 600 to protect the first end portion 109 of the first connector body 10. And because a friction between metals is less than a friction between plastics, while the first strengthening member 30 guides the second electrical connector 600, the first strengthening member 30 is beneficial to reduce resistance to the second electrical connector 600, so that the second electrical connector 600 is more easily inserted into the first electrical connector 100, and the guiding effect is promoted. An upper surface of the connecting segment 3023b of the extending portion 3023 also is not lower than the upper surface of the side wall 101 of the first connector body 10 (an upper surface of a part, which carries the connecting segment 3023b, of the side wall 101), so that, while the connecting segment 3023b provides guiding for the second electrical connector 600, the connecting segment 3023b protects an inner side of the side wall 101 of the first connector body 10. And, the connecting segment 3023b also is made from the metal material, which also is beneficial to reduce a friction with the first electrical connector 100 when the second electrical connector 600 is inserted into the first electrical connector 100, the guiding effect is further improved.

As shown in FIGS. 4-7, a lower portion of the side plate portion 3021 is connected to the first soldering portion 304, the first soldering portion 304 is formed to bend outwardly from a lower end of the side plate portion 3021, and the first soldering portion 304 is exposed at a bottom surface of the first connector body 10. The bottom surface of the first connector body 10 in positions respectively corresponding to two sides of the first soldering portion 304 along the first direction is provided with first cooperating notches 110 which each are recessed upwardly. In the overmolding process of the two first strengthening member 30 and the first connector body 10, mold inserts may be fixed to the position as shown by the first cooperating notches 110, so that the first soldering portion 304 is fixed, which maintains that positions of the first strengthening member 30 and the first connector body 10 do not offset relative to each other in the overmolding process. The first cooperating notches 110 sufficiently use a space of the first connector body 10, may be adapted to manufacturing of an electrical connector which is small in dimension, lowers possibility of flash in manufacturing, and promotes manufacturing yield. As shown in FIG. 3 and FIG. 8, the side wall covering portion 302 is blocked from the first soldering portion 304 in a vertical direction by the first connector body 10 which is made from the plastic material, which effectively avoids solder wicking and solder climbing. A lower end of the end wall covering portion 301 extends and bends outwardly to form a soldering portion (not given a reference numeral in the figure), the end wall covering portion 301 is blocked from the soldering portion in the vertical direction by the first electrical connector 100 which is made from the plastic material, which effectively avoids solder wicking and solder climbing.

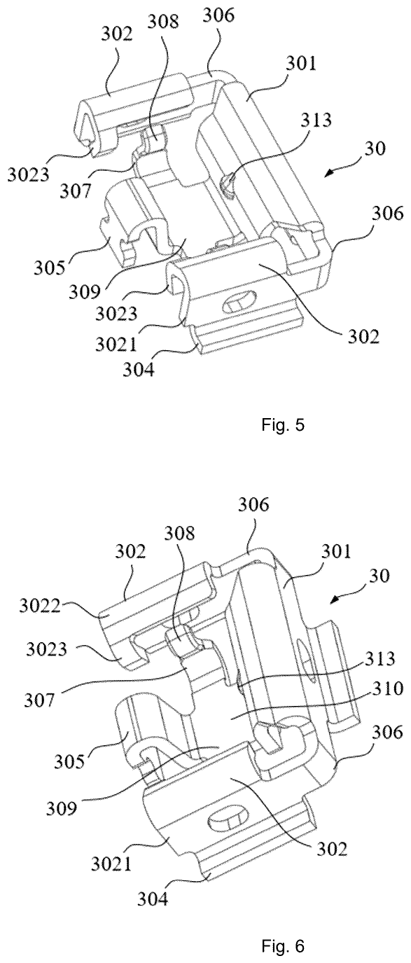

As shown in FIG. 3, FIG. 5 and FIG. 8, each first strengthening member 30 further includes two elastic arms 307, the two elastic arms 307 are connected to two sides of the bottom surface covering portion 309 in the x direction, and a top end of each elastic arm 307 is provided with a contacting end 308, a height of the contacting end 308 is lower than a height of the upper covering portion 3022. When the second electrical connector 600 is inserted into the first connector body 10, the upper covering portion 3022 provides guiding for the second electrical connector 600, so that the second strengthening member 80 of the second electrical connector 600 enters into between the two elastic arms 307, the two elastic arms 307 maintain mating stability between the second electrical connector 600 and the first electrical connector 100, and the contacting ends 308 of the two elastic arms 307 come into contact and establish electrical connection with the second strengthening member 80 of the second electrical connector 600.

As shown in FIG. 1 and FIG. 8, after the first electrical connector 100 and the second electrical connector 600 are mated with each other, the contacting end 308 abuts against the second strengthening member 80 of the second electrical connector 600, and the contacting end 308 is positioned closer to the central axis S0 of the first connector body 10 than a part of the extending portion 3023 exposed from the first connector body 10, so that, when the second strengthening member 80 is electrically connected to the elastic arm 307, electrical connection is established only by the contacting end 308 which protrudes inwardly, which realizes point contact electrical connection between the second strengthening member 80 and the elastic arm 307, in comparison with surface contact electrical connection, the point contact electrical connection has lower contact electric resistance.

As shown in FIG. 5 and FIG. 8, an inner side of the end wall covering portion 301 is provided with at least one contact protrusion 313 which protrudes inwardly. As shown in FIG. 8, FIG. 10 and FIG. 18, after the first electrical connector 100 and the second electrical connector 600 are mated with each other, the contact protrusion 313 abuts against and establishes electrical connection with the second strengthening member 80 of the second electrical connector 600. Therefore, the contacting ends 308 of the two elastic arms 307 of the first strengthening member 30 respectively act as a first contact point and a second contact point of electrical connection of the first strengthening member 30 with the second strengthening member 80, to come into contact and establish electrical connection with the second strengthening member 80. The contact protrusion 313 acts as a third contact point, also comes into contact and establishes electrical connection with the second strengthening member 80, and the contact protrusion 313 and the second strengthening member 80 therebetween also is a point contact connection rather than surface contact connection. Therefore, the first strengthening member 30 and the first power terminal 201 respectively connect to the second strengthening member 80 and the second power terminal 701 (FIG. 10), and the first strengthening member 30 of the first electrical connector 100 and the second strengthening member 80 of the second electrical connector 600 therebetween have three or more electrical contact points, which lowers contact electric resistance between the first strengthening member 30 and the second strengthening member 80, may allow larger current to flow through the first electrical connector 100 and the second electrical connector 600, may make the first electrical connector 100 and the electrical connector assembly better adapted to large current situation, capable of passing temperature rise test of large current very well, thereby being beneficial to expand application range of the electrical connector, and thus solving the technical problem that the electrical connector is difficult to pass temperature rise test of large current and cannot be applied to large current situation in the prior art.

As shown in FIG. 10 and FIG. 11, the second electrical connector 600 includes a second connector body 60, a plurality of second terminals 70 attached to the second connector body 60, and two second strengthening members 80 respectively provided at two ends of the second connector body 60. The second connector body 60 includes a top plate 603 and the two second protrusions 605 which extend along the first direction, a second recess 604 is formed between the two second protrusions 605. The two second protrusions 605 are provided with a plurality of second terminals receiving cavities 607. The plurality of second terminals 70 are respectively provided in the plurality of second terminal receiving cavities 607. The plurality of second terminals 70 includes a plurality of second signal terminals 702 and a plurality of second power terminals 701. The two second strengthening members 80 are respectively provided to the second end portions 609 at the two ends of the second connector body 60. The plurality of second power terminals 701 are provided between the plurality of second signal terminals 702 and the two second strengthening members 80. The second connector body 60 for example is made from a plastic material or other macromolecule polymer material, the second strengthening member 80 for example is made from a conductive metal material (for example copper, copper alloy, nickel alloy and the like). The second connector body 60 and the two second strengthening members 80 also are tightly engaged together by overmolding, the second strengthening member 80 strengthens and protects the second end portion 609 of the second connector body 60 in structure.

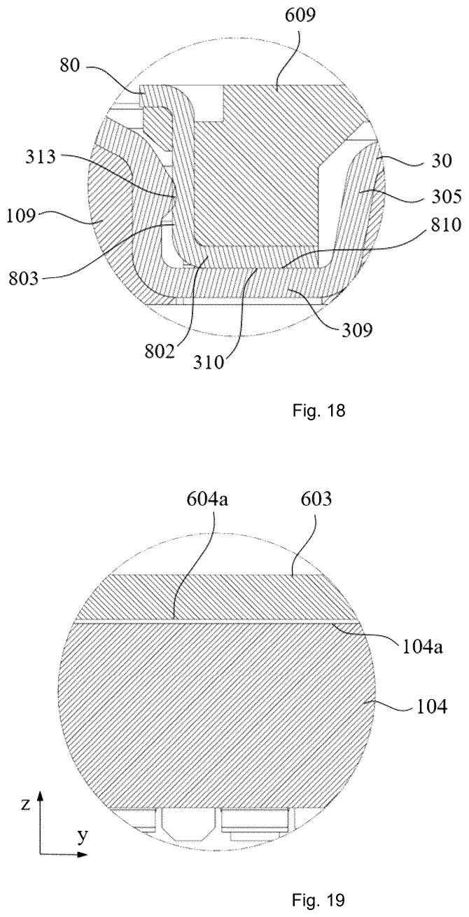

As shown in FIG. 1, FIG. 10 and FIG. 17, when the second electrical connector 600 and the first electrical connector 100 are mated with each other, the two second protrusions 605 of the second electrical connector 600 are respectively fitted into the first recesses105 of the first electrical connector 100, the first protrusion 104 of the first electrical connector 100 is fitted into the second recess 604 of the second electrical connector 600. The first signal terminal 202 and the second signal terminal 702 establish electrical connection, the first power terminal 201 and the second power terminal 701 establish electrical connection. The first strengthening member 30 and the second strengthening member 80 come into contact and establish electrical connection.

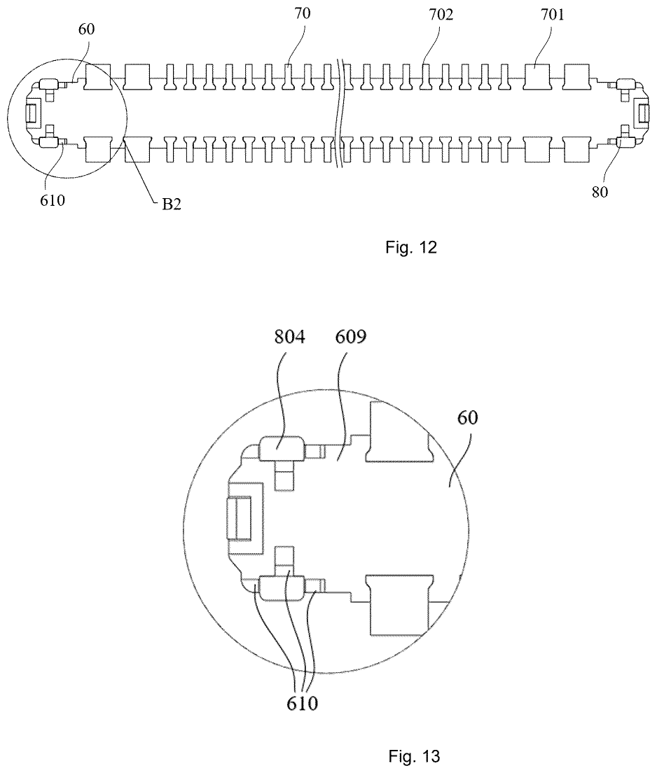

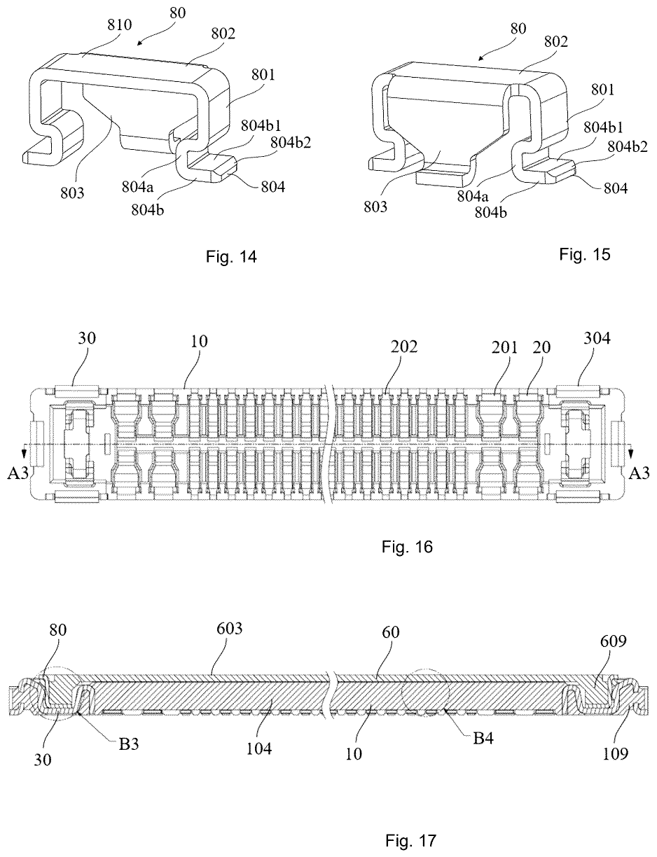

As shown in FIGS. 10-15, the second strengthening member 80 includes side covering portions 801, a middle covering portion 802 and an outside covering portion 803. The side covering portions 801 are attached to the second protrusion 605, the middle covering portion 802 is attached to a lower surface of the second end portion 609, the outside covering portion 803 is attached to an outer wall of the second end portion 609. An upper end of the side covering portion 801 extends and firstly bends inwardly, then bends upwardly, and next bends outwardly to form a second soldering portion 804, the second soldering portion 804 is exposed at a top surface of the second connector body 60. Selectively, the second soldering portion 804 includes a bending portion 804a which bends inwardly and extends upwardly and a soldering end portion 804b which extends outwardly. A lower surface of the soldering end portion 804b includes a connecting plane 804b1 and an oblique surface 804b2, the oblique surface 804b2 extends from a side of the connecting plane 804b1 toward an upper surface of the soldering end portion 804b direction to form oblique tendency which is outward and upward relative to the connecting plane 804b1. After the first electrical connector 100 and the second electrical connector 600 are mated with each other, the oblique surface 804b2 increases a distance between a lower surface of the second soldering portion 804 and the first strengthening member 30, which avoids a solder accumulated due to solder climbing and the like at the second soldering portion 804 contacting the first strengthening member 30 to affect a connecting state between the first strengthening member 30 and the second strengthening member 80. As shown in FIG. 12 and FIG. 13, the top surface of the second connector body 60 in a position corresponding to the second soldering portion 804 is provided with at least one second cooperating notch 610 which is recessed downwardly, the at least one second cooperating notch 610 is positioned at two sides of the second soldering portion 804 along the first direction and/or the at least one second cooperating notch 610 is positioned at an inner side of the second soldering portion 804. FIG. 13 exemplarily illustrates that three second cooperating notches 610 are provided, in different embodiments, the number and the position of the second cooperating notch 610 may be selected as desired, and are not limited to those as shown here. In an overmolding process of the second connector body 60 and the second strengthening member 80, mold inserts may be fixed at the positions as shown by the second cooperating notches 610, which sufficiently uses a space of the second connector body 60, may be adapted to manufacturing of an electrical connector which is small in dimension, lowers possibility of flash in manufacturing, and improves manufacturing yield. The side covering portion 801 is also blocked from the second soldering portion 804 by the second connector body 60 which is made from the plastic material, which effectively avoids solder wicking and solder climbing.

As shown in FIGS. 16-19, an upper side surface of the bottom surface covering portion 309 of each first strengthening member 30 is a first stopping surface 310. A bottom surface of the middle covering portion 802 of each second strengthening member 80 is a second stopping surface 810. After the second electrical connector 600 and the first electrical connector 100 are mated with each other, the first stopping surface 310 of the first strengthening member 30 and the second stopping surface 810 of the second strengthening member 80 abut against each other. Therefore, the first stopping surface 310 is configured to stop the second stopping surface 810 of the second strengthening member 80, so as to limit mating position between the first electrical connector 100 and the second electrical connector 600 in position. With limiting of the first stopping surface 310 and the second stopping surface 810 in position, after the second electrical connector 600 and the first electrical connector 100 are mated with each other, a top surface 104a of the first protrusion 104 and a bottom surface 604a of the second recess 604 therebetween have a gap in height, a height of the gap for example is about 0.01 mm, in practice, the height of the gap practical may be different as a dimension of an electrical connector product is different.

Therefore, in an electrical connector assembly which is small in dimension and whose length is longer, in a process that the second electrical connector 600 is inserted into the first electrical connector 100, the gap between the top surface 104a of the first protrusion 104 and the bottom surface 604a of the second recess 604 allows the second electrical connector 600 to have tendency of moving toward a mating direction, which prevents one side of the second electrical connector 600 from being abutted against and the other side of the second electrical connector 600 from being warped, which is beneficial to attain a good mating state, can bring good “click” sense during mating, such a sense feedback can allow a user to know whether mating is completed.

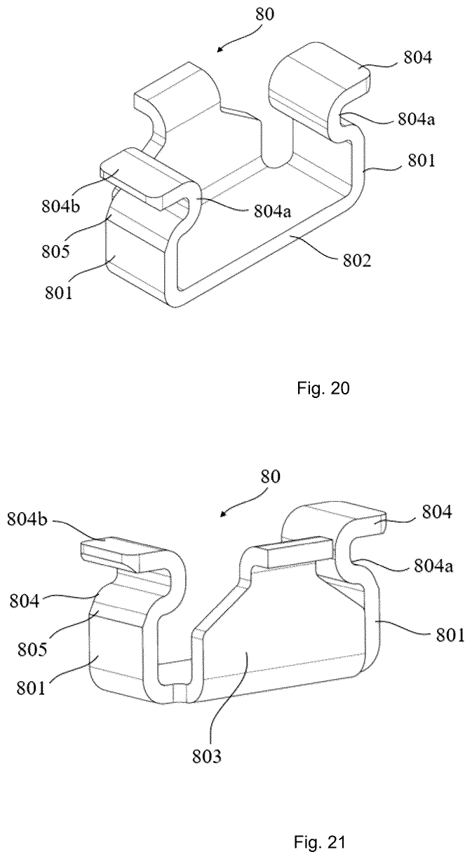

FIG. 20 and FIG. 21 are structure schematic views of a second strengthening member of another embodiment of the present disclosure. In the another embodiment, the side covering portion 801 of the second strengthening member 80 is connected to the bending portion 804a of the second soldering portion 804 via a transitioning portion 805, an outer side surface of the side covering portion 801 is a plane, an outer side surface of the transitioning portion 805 also is a plane, therefore, a connected location between the outer side surface of the transitioning portion 805 and the outer side surface of the side covering portion 801 is a straight line, the outer side surface of the transitioning portion 805 and the outer side surface of the side covering portion 801 therebetween have a clear boundary. A side of the transitioning portion 805 away from the side covering portion 801 sequentially bends inwardly and extends upwardly to form the bending portion 804a, a side of the bending portion 804a away from the transitioning portion 805 bends outwardly to form a soldering end portion 804b. In this embodiment, by that the transitioning portion 805 is provided between the side covering portion 801 and the bending portion 804a of the second soldering portion 804 and a clear boundary is formed, it avoids defects such as short shot, flash and the like of the plastic at the connected position between the side covering portion 801 and the second soldering portion 804 during overmolding which would make sealing performance of molding poor. Therefore, by that the transitioning portion 805 is provided to make the second soldering portion 804 and the side covering portion 801 therebetween have a clear boundary, the sealing performance of molding is significantly improved.

In conclusion, the electrical connector and the electrical connector assembly have the following advantages.

With the present disclosure, the two ends of the first connector body 10 are respectively provided with the two first strengthening members 30, which strengthen protection for the end portions 109 of the first electrical connector 100, the side wall covering portion 302 of the first strengthening member 30 is provided with the extending portion 3023, and at least a part of the extending portion 3023 is completely embedded in the side wall 101 of the first connector body 10, so that engagement strength between the first strengthening member 30 and the first connector body 10 is promoted, even if the first connector body 10 is inserted into or pulled out from the second electrical connector 600 many times, the first strengthening member 30 is not prone to be separated from the first connector body 10, which provides continuous protection for the first electrical connector 100, and improves use reliability and service life of the electrical connector and the electrical connector assembly. The electrical connector and the electrical connector assembly are more compact in structure, and are more reasonable in space utilization, which is beneficial to obtain a smaller overall size, and may be applied to small space application situation. The electrical connector and the electrical connector assembly are simple in manufacturing, are lower in cost, may be applied to high-current application situation, and are wider in application ranges.

The above content is a further detailed description of the present disclosure in conjunction with the specific preferred embodiments, and it cannot be considered that the specific implementation of the present disclosure is only limited to these description. For ordinary technical personnel in the technical field to which the present disclosure belongs, without departing from the concept of the present disclosure, several simple deductions or substitutions can be made, and should be considered as belonging to the scope of protection of the present disclosure.

What is claimed is:

1. An electrical connector, comprising a connector body, a plurality of terminals attached to the connector body and two strengthening members respectively attached to two ends of the connector body;
wherein
each strengthening member comprises:
an end wall covering portion attached to an end wall of the connector body; and
a pair of side wall covering portions respectively attached to two side walls of the connector body, each side wall covering portion is connected to the end wall covering portion via a connecting portion;
each side wall covering portion comprises a side plate portion, an upper covering portion connected to an upper portion of the side plate portion and an extending portion connected to a part of the upper covering portion, the upper covering portion at least partially covers an upper portion of the side wall of the connector body, at least a part of the extending portion is completely embedded in the side wall of the connector body.

2. The electrical connector according to claim 1, wherein
the extending portion comprises a connecting segment and an embedded segment,
the embedded segment is connected to an inner side of the upper covering portion via the connecting segment, the embedded segment is completely embedded in the side wall of the connector body.

3. The electrical connector according to claim 2, wherein
the connecting segment extends downwardly and inwardly relative to the upper covering portion;
the embedded segment extends outwardly relative to the connecting segment.

4. The electrical connector according to claim 1, wherein
two sides of the extending portion in a first direction each are provided with the connector body, the first direction is an extending direction of the side wall of the connector body.

5. The electrical connector according to claim 2, wherein
an upper surface of the upper covering portion and/or an upper surface of the connecting segment of the extending portion is not lower than an upper surface of the side wall of the connector body.

6. The electrical connector according to claim 1, wherein
a lower portion of the side plate portion is connected to a soldering portion;
the soldering portion is exposed at a bottom surface of the connector body, and
the bottom surface of the connector body in positions respectively corresponding to two sides of the soldering portion along a first direction is provided with notches which each are recessed upwardly, the first direction is an extending direction of the side wall of the connector body.

7. The electrical connector according to claim 1, wherein
each strengthening member further comprises a bottom surface covering portion and two elastic arms;
the two elastic arms are respectively connected to two sides of the bottom surface covering portion, and a top end of each elastic arm is provided with a contacting end, a height of the contacting end is lower than a height of the upper covering portion.

8. The electrical connector according to claim 7, wherein
after the electrical connector is mated with a counterpart electrical connector, the contacting end abuts against a counterpart strengthening member of the counterpart electrical connector, and the contacting end is positioned closer to a central axis of the connector body than a part of the extending portion which is exposed from the connector body.

9. The electrical connector according to claim 7, wherein
an upper surface of an inner side of the upper covering portion is an oblique guiding surface, and
an angle between an outer surface of an end portion of the elastic arm and a height direction is not less than an angle between the oblique guiding surface and the height direction.

10. The electrical connector according to claim 1, wherein
each strengthening member further comprises a bottom surface covering portion;
an upper side surface of the bottom surface covering portion is a stopping surface;
the stopping surface is configured to stop a counterpart strengthening member of a counterpart electrical connector.

11. An electrical connector assembly, comprising the electrical connector of claim 1 and a counterpart electrical connector which is mated with the electrical connector.

12. The electrical connector assembly according to claim 11, wherein
each strengthening member further comprises a bottom surface covering portion, an inner side surface of the bottom surface covering portion serves as a first stopping surface;
the counterpart electrical connector comprises a counterpart connector body and two counterpart strengthening members respectively provided at two ends of the counterpart connector body, each counterpart strengthening member comprises a second stopping surface;
the first stopping surface and the second stopping surface abut against each other.

13. The electrical connector assembly according to claim 12, wherein
the counterpart connector body comprises a recess;
the connector body comprises a protrusion, the protrusion is fitted into the recess, and a top surface of the protrusion and a bottom surface of the recess therebetween have a gap in height.

14. The electrical connector assembly according to claim 11, wherein
the counterpart electrical connector comprises a counterpart connector body and two counterpart strengthening members respectively provided at two ends of the counterpart connector body;
the counterpart strengthening member comprises at least one counterpart soldering portion, the counterpart soldering portion is exposed at a top surface of the counterpart connector body;
the top surface of the counterpart connector body in a position corresponding to the counterpart soldering portion is provided with at least one cooperating notch which is recessed downwardly, the at least one cooperating notch is positioned at two sides of the counterpart soldering portion along a first direction and/or the at least one cooperating notch is positioned at an inner side of the counterpart soldering portion, the first direction is an extending direction of the side wall of the connector body.

15. The electrical connector assembly according to claim 14, wherein
the counterpart soldering portion comprises a soldering end portion which extends outwardly;
a lower surface of the soldering end portion comprises a connecting plane and an oblique surface, the oblique surface extends from a side of the connecting plane toward an upper surface of the soldering end portion.

16. The electrical connector assembly according to claim 14, wherein
the counterpart strengthening member further comprises a side covering portion and a transitioning portion;
the counterpart soldering portion comprises a bending portion which bends inwardly and extends upwardly and a soldering end portion which extends outwardly;
the bending portion is connected to the side covering portion via the transitioning portion, a connected location between an outer side surface of the transitioning portion and an outer side surface of the side covering portion is a straight line.
